(19) United States
(12) Patent Application Publication
(10) Pub. No.: US 2026/0029621 A1
(43) Pub. Date: Jan. 29, 2026

(54) IMAGING LENS SYSTEM, CAMERA MODULE, IN-VEHICLE SYSTEM, AND VEHICLE

(71) Applicant: Maxell, Ltd., Kyoto (JP)

(72) Inventor: Shun YOSHIKAWA, Otokuni-gun, Kyoto (JP)

(73) Assignee: Maxell, Ltd., Kyoto (JP)

(21) Appl. No.: 18/994,613

(22) PCT Filed: Jun. 7, 2023
(86) PCT No.: PCT/JP2023/021109

§ 371 Date: Jan. 15, 2025

(30) Foreign Application Priority Data
Jul. 15, 2022 (JP) 2022-113780

(51) Int. Cl. G02B 13/00; G02B 9/60; G03B 30/00

(52) U.S. Cl. CPC G02B 13/0045; G02B 9/60; G02B 13/006; G03B 30/00

(57) ABSTRACT

An imaging lens system that includes a first lens having negative power, a second lens having negative power, a third lens having positive power, an iris, a fourth lens having positive power, and a fifth lens and a sixth lens constituting a cemented lens, one of the lenses having negative power and another of the lenses having positive power, the imaging lens system satisfying −5.0<f1/f<−3.0, 2.7<f4/f<3.1, νd4>60, and 6.0<f3/f<10.0, where f1 is defined as a focal length of the first lens, f4 is defined as a focal length of the fourth lens, νd4 is defined as an Abbe's number of a d-line of the fourth lens, f3 is defined as a focal length of the third lens, and f is defined as a focal length of an entire optical system.

### TECHNICAL FIELD

The present invention relates to an imaging lens system, a camera module, an in-vehicle system, and a vehicle.

### BACKGROUND ART

In recent years, sensing capabilities have been required for on-board cameras mounted on cars and monitoring cameras, and resolutions of capturing elements are becoming higher, while sizes thereof have been increasing. Accordingly, imaging lens systems mounted on on-board cameras, etc., have also tended to be getting larger. Specifically, an aperture of a first lens (the lens nearest to an object side) of the imaging lens system has tended to be getting larger. For example, Patent Literature 1 describes an imaging lens system consisting of six lenses mounted on an on-board camera, etc., and an aperture (effective diameter) of a first lens is about three times a diagonal length of a capturing element, resulting in a relatively large optical system.

### CITATION LIST

### Patent Literature

Patent Literature 1: Japanese Unexamined Patent Application Publication No. 2016-057562

### SUMMARY OF INVENTION

### Technical Problem

On the other hand, in recent years, due to a demand of omnidirectional sensing of the periphery of a car, on-board cameras are starting to be attached to positions where there is a spatial limitation such as a side mirror. Thus, downsizing of on-board cameras has been required. Moreover, on-board cameras may be attached instead of side mirrors, and thus further downsizing of on-board cameras has been required. The imaging lens system described in Patent Literature 1 is a relatively large optical system, and it is difficult to meet the demand of downsizing on-board cameras.

The present invention has been made in view of such problems, and an object of the present invention is to provide an imaging lens system, a camera module, an in-vehicle system, and a vehicle, which can achieve a high resolution and are downsized.

### Solution to Problem

An imaging lens system according to an embodiment includes, sequentially from an object side toward an image side: a first lens having negative power with an image-side surface whose concave surface faces the image side; a second lens having negative power with an image-side surface whose concave surface faces the image side; a third lens having positive power with an image-side surface whose convex surface faces the image side; an iris; a fourth lens having positive power with an object-side surface whose convex surface faces the object side; and a fifth lens and a sixth lens constituting a cemented lens, one of the lenses having negative power and another of the lenses having positive power, in which the imaging lens system satisfies the following Conditional Expressions (1) to (4):

$$- 5. < f 1 / f < - 3. , \qquad ( 1 )$$

$$2.7 < f 4 / f < 3.1 , \qquad ( 2 )$$

$$vd 4 > 60 , and \qquad ( 3 )$$

$$6. < f 3 / f < 10. \qquad ( 4 )$$

where f1 is defined as a focal length of the first lens, f4 is defined as a focal length of the fourth lens, νd4 is defined as an Abbe's number of a d-line of the fourth lens, f3 is defined as a focal length of the third lens, and f is defined as a focal length of an entire optical system.

### Advantageous Effects of Invention

According to the present invention, it is possible to provide an imaging lens system, a camera module, an in-vehicle system, and a vehicle, which can achieve a high resolution and are downsized.

### BRIEF DESCRIPTION OF DRAWINGS

FIG. 1 is a cross-sectional view showing a configuration of a camera module and an imaging lens system according to Example 1;

FIG. 2A is a spherical aberration diagram (longitudinal aberration diagram) of the imaging lens system according to Example 1;

FIG. 2B is a field curvature diagram of the imaging lens system according to Example 1;

FIG. 2C is a distortion diagram of the imaging lens system according to Example 1;

FIG. 2D is a lateral color aberration diagram of the imaging lens system according to Example 1;

FIG. 3 is a cross-sectional view showing a configuration of a camera module and an imaging lens system according to Example 2;

FIG. 4A is a spherical aberration diagram (longitudinal aberration diagram) of the imaging lens system according to Example 2;

FIG. 4B is a field curvature diagram of the imaging lens system according to Example 2;

FIG. 4C is a distortion diagram of the imaging lens system according to Example 2;

FIG. 4D is a lateral color aberration diagram of the imaging lens system according to Example 2;

FIG. 5 is a cross-sectional view showing a configuration of a camera module and an imaging lens system according to Example 3;

FIG. 6A is a spherical aberration diagram (longitudinal aberration diagram) of the imaging lens system according to Example 3;

FIG. 6B is a field curvature diagram of the imaging lens system according to Example 3;

FIG. 6C is a distortion diagram of the imaging lens system according to Example 3;

FIG. 6D is a lateral color aberration diagram of the imaging lens system according to Example 3;

FIG. 7 is a cross-sectional view showing a configuration of a camera module and an imaging lens system according to Example 4;

FIG. 8A is a spherical aberration diagram (longitudinal aberration diagram) of the imaging lens system according to Example 4;

FIG. 8B is a field curvature diagram of the imaging lens system according to Example 4;

FIG. 8C is a distortion diagram of the imaging lens system according to Example 4;

FIG. 8D is a lateral color aberration diagram of the imaging lens system according to Example 4;

FIG. 9 is a cross-sectional view showing a configuration of a camera module and an imaging lens system according to Example 5;

FIG. 10A is a spherical aberration diagram (longitudinal aberration diagram) of the imaging lens system according to Example 5;

FIG. 10B is a field curvature diagram of the imaging lens system according to Example 5;

FIG. 10C is a distortion diagram of the imaging lens system according to Example 5;

FIG. 10D is a lateral color aberration diagram of the imaging lens system according to Example 5;

FIG. 11 is an overview diagram of a car including an in-vehicle system with a camera module according to an embodiment of the present invention; and

FIG. 12 is a block diagram showing a configuration of a capturing apparatus constituting the in-vehicle system of FIG. 11.

### DESCRIPTION OF EMBODIMENTS

An embodiment of the present invention will be described below with reference to the drawings. In this embodiment, a highly reliable system can be implemented, especially in a sensing system, and contributes to the development of a resilient infrastructure. The target of this embodiment is “9. Build resilient infrastructure, promote inclusive and sustainable industrialization and foster innovation” of the United Nations Sustainable Development Goals (SDGs), “9.1 Develop quality, reliable, sustainable and resilient infrastructure, including regional and transborder infrastructure, to support economic development and human well-being, with a focus on affordable and equitable access for all”.

In the present embodiment, a volume of a glass material used in the first lens can be made further smaller, and an aberration generated due to the reduction in the size of the aperture of the first lens can be corrected without increasing the number of lenses constituting the imaging lens system. The target of the present embodiment is “12. Ensure sustainable consumption and production patterns” of the United Nations Sustainable Development Goals, “12.8 By 2030, ensure that people everywhere have the relevant information and awareness for sustainable development and lifestyles in harmony with nature”.

### First Embodiment: Imaging Lens System

An imaging lens system according to a first embodiment includes a first lens having negative power with an image-side surface whose concave surface faces an image side, a second lens having negative power with an image-side surface whose concave surface faces the image side, a third lens having positive power with an image-side surface whose convex surface faces the image side, an iris, a fourth lens having positive power with an object-side surface whose convex surface faces an object side, and a fifth lens and a sixth lens constituting a cemented lens, one of the lenses having negative power and another of the lenses having positive power, in which the imaging lens system satisfies the following Conditional Expressions (1) to (4):

$$- 5. < f 1 / f < - 3. , \qquad ( 1 )$$

$$2.7 < f 4 / f < 3.1 , \qquad ( 2 )$$

$$vd 4 > 60 , and \qquad ( 3 )$$

$$6. < f 3 / f < 10. \qquad ( 4 )$$

where f1 is defined as a focal length of the first lens, f4 is defined as a focal length of the fourth lens, νd4 is defined as an Abbe's number of a d-line of the fourth lens, f3 is defined as a focal length of the third lens, and f is defined as a focal length of an entire optical system.

Thus, it is possible to provide the imaging lens system, which can achieve a high resolution and is downsized.

Specifically, with the power of the first lens being relatively strong such that Conditional Expression (1) is satisfied, a smaller aperture of the first lens is achieved, and the optical system can be downsized. More specifically, if the value of f1/f is −3.0 or more, the focal length of the first lens becomes too long with respect to the focal length of the entire optical system, i.e., the power of the first lens becomes too weak, while the aperture of the first lens becomes large, and thus the imaging lens system cannot be certainly downsized. Meanwhile, if the value of f1/f is −5.0 or less, the focal length of the first lens becomes too short with respect to the focal length of the entire optical system, i.e., the power of the first lens becomes too strong, and thus although a smaller aperture of the first lens can be achieved, a lateral color aberration generated in the first lens becomes too strong, resulting in worsening of imaging performance of the imaging lens system. The value of f1/f is more preferably −3.15 or more and −3.70 or less.

With the power of the fourth lens satisfying Conditional Expression (2), a high resolution can be achieved more certainly. Specifically, if the value of f4/f is 3.1 or more, the focal length of the fourth lens becomes too long with respect to the focal length of the entire optical system, i.e., the power of the fourth lens becomes too weak, while the total length of the optical system becomes long, and thus the imaging lens system cannot be certainly downsized. Meanwhile, if the value of f4/f is 2.7 or less, the focal length of the fourth lens becomes too short with respect to the focal length of the entire optical system, i.e., the power of the fourth lens becomes too strong, while the total length of the optical system becomes short, and thus error sensitivity of the imaging performance becomes high, resulting in easier occurrence of a manufacturing error. The value of f4/f is more preferably 2.75 or more and 2.95 or less.

With the Abbe's number νd4 of the fourth lens satisfying Conditional Expression (3), the lateral color aberration generated in the first lens is corrected, and a high resolution can be achieved. Specifically, if the Abbe's number νd4 of the fourth lens is 60 or less, the lateral color aberration generated in the first lens cannot be sufficiently corrected. The Abbe's number νd4 of the fourth lens is more preferably 63 or greater and even more preferably 68 or greater.

With the power of the third lens satisfying Conditional Expression (4), a distance from an incident pupil to the iris (a distance on the optical axis from the object-side surface of the first lens to the iris) can be shortened, and the optical system can be downsized. Specifically, if the value of f3/f is 10.0 or more, the focal length of the third lens becomes too long with respect to the focal length of the entire optical system, i.e., the power of the third lens becomes too weak, and a space between the first lens and the iris will be broadened, resulting in necessity of enlarging the aperture of the first lens and failure of downsizing the imaging lens system. Meanwhile, if the value of f3/f is 6.0 or less, the focal length of the third lens becomes too short with respect to the focal length of the entire optical system, i.e., the power of the third lens becomes too strong, and a space between the first lens and the iris will be narrowed, resulting in achievement of a smaller aperture of the first lens. However, the lateral color aberration generated in the first lens becomes too large, and the imaging performance of the imaging lens system will be worsened. The value of f3/f is more preferably 6.5 or more and 9.5 or less, and even more preferably 8.0 or more and 9.0 or less.

Thus, the imaging lens system, which can achieve a high resolution and is downsized, can be provided.

The imaging lens system preferably satisfies the following Conditional Expression (5):

$$9 < TTL / f < 11 \qquad ( 5 )$$

where TTL is defined as a distance on the optical axis from the object-side surface of the first lens to a focal plane of a capturing element, and f is defined as the focal length of the entire optical system.

With the above Conditional Expression (5) being satisfied, the imaging lens system can certainly be downsized. Specifically, if the value of TTL/f is 11 or more, the imaging lens system cannot be certainly downsized. Meanwhile, if the value of TTL/f is 9 or less, each lens needs to be downsized, and the difficulty of manufacturing becomes high, resulting in worsening of a manufacturing yield and an increase in the cost of components. The value of TTL/f is more preferably 9.3 or more and 10.5 or less, and even more preferably 9.5 or more and 10.0 or less.

The imaging lens system preferably satisfies the following Conditional Expression (6):

$$10. < \vert f 5 / f \vert < 30. \qquad ( 6 )$$

where f5 is defined as a focal length of the fifth lens, and f is defined as the focal length of the entire optical system.

With the above Conditional Expression (6) being satisfied, color aberrations on the axis generated due to the use of a glass material satisfying the Conditional Expression (2) and the Conditional Expression (3) for the fourth lens can be optimally corrected. Specifically, if the value of |f5/f| is 30.0 or more, the power of the fifth lens becomes too weak, and color aberrations on the axis cannot be sufficiently corrected, resulting in degradation of resolution performance of the imaging lens system. Meanwhile, if the value of |f5/f| is 10.0 or less, the power of the fifth lens becomes too strong, and correction of the color aberrations on the axis becomes too excessive, resulting in degradation of the resolution performance of the imaging lens system. The value of |f5/f| is more preferably 13.0 or more and 28.5 or less, and even more preferably 14.5 or more and 22.0 or less.

The following Conditional Expression (7) is preferably satisfied:

$$nd 1 > 1.8 \qquad ( 7 )$$

where nd1 is defined as a d-line refractive index of the first lens.

With the above Conditional Expression (7) being satisfied, a smaller aperture of the first lens can be achieved. Specifically, if the value of nd1 is 1.8 or less, the power of the first lens becomes too weak, and a smaller aperture of the first lens cannot be achieved. The value of nd1 is more preferably 1.83 or more, and even more preferably 1.84 or more.

The first lens and the fourth lens are preferably glass lenses, and the second lens, the third lens, the fifth lens, and the sixth lens are preferably plastic lenses.

With the first lens being a glass lens, an imaging lens system excellent in weather resistance can be provided.

With the fourth lens being a glass lens, an imaging lens system in which a focus shift due to an environmental temperature change is reduced can be provided. Specifically, with the use of a glass lens for the fourth lens, a glass material in which a temperature coefficient dnd4/dT of a refractive index for the d-line is less than 0 can be selected as the glass material of the fourth lens. Thus, with a focus shift range due to a temperature change of the fourth lens itself, a change in a distance (focus shift range) from a lens surface of the object side of the first lens to the focal plane of the capturing element caused by elongation/contraction of a lens barrel in an optical axis direction due to an environmental temperature change can be offset. In particular, in an imaging lens system for mounting on vehicles, at the time of a high temperature, elongation of a lens barrel in an optical axis direction brings a focal plane of a capturing element away from the imaging lens system, but with a focal point of the fourth lens being shifted to the image side when the fourth lens reaches a high temperature, imaging performance of the imaging lens system can be maintained.

Meanwhile, with the second lens, the third lens, the fifth lens, and the sixth lens being plastic lenses, the manufacturing cost can be reduced.

An object-side surface and the image-side surface of the second lens preferably have aspherical surface shapes, and the object-side surface of the second lens preferably has an inflection point.

Allowing the first lens to have a smaller aperture causes a demerit in that adjustment of a relationship between an angle of view and an image height of an image formed in the capturing element (hereinafter, referred to as the “angle of view characteristic”) becomes difficult. However, with the object-side surface of the second lens having the inflection point, the adjustment of the angle of view characteristic can be made easy. Thus, it is possible to suppress a decrease in peripheral light quantity, which is an issue in a wide-angle imaging lens system. Specifically, with the object-side surface of the second lens having an inflection point, for example, it is possible to intentionally form an image with a small peripheral magnification on the focal plane, thereby suppressing a decrease in peripheral light quantity.

### Second Embodiment: Camera Module

A camera module according to a second embodiment includes the imaging lens system described above and a capturing element arranged at a focal position of the imaging lens system, the capturing element converting light converged through the imaging lens system into an electrical signal. Thus, a camera module which can achieve a high resolution and is downsized can be provided.

Next, examples of the imaging lens system according to the first embodiment and the camera module according to the second embodiment will be described with reference to the drawings.

### Example 1

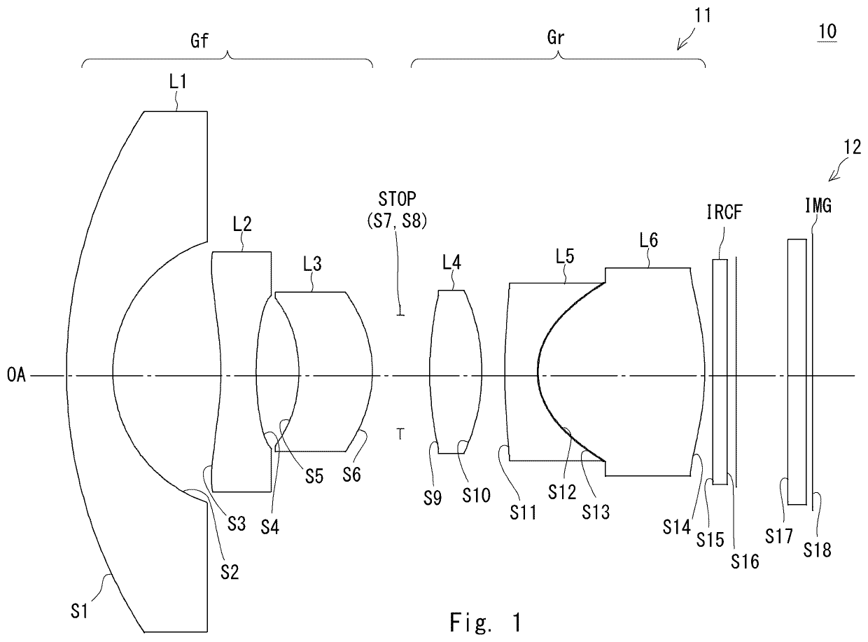

FIG. 1 is a cross-sectional view showing a configuration of a camera module 10 according to Example 1. Specifically, the camera module 10 includes an imaging lens system 11 and a capturing element 12. The imaging lens system 11 and the capturing element 12 are housed in a lens barrel (not shown).

The capturing element 12 is an element for converting received light into an electrical signal, and for example, a CCD image sensor or a CMOS image sensor is used. The capturing element 12 is arranged at an imaging position (focal position) of the imaging lens system 11.

The imaging lens system 11 according to Example 1 is composed of, sequentially from the object side toward the image side, a front lens group Gf composed of a first lens L1, a second lens L2, and a third lens L3, an aperture iris (STOP), and a rear lens group Gr composed of a fourth lens L4, a fifth lens L5, and a sixth lens L6. A focal plane of the imaging lens system 11 is shown by the abbreviation IMG. The first lens L1 and the fourth lens L4 are glass lenses. The second lens L2, the third lens L3, the fifth lens L5, and the sixth lens L6 are plastic lenses.

Note that an optical filter (infrared cut filter, visible/infrared light band-pass filter, or the like) is arranged between the imaging lens system 11 and the capturing element 12, as necessary. Descriptions will be made herein with an example in which an infrared cut filter (IRCF) is arranged between the imaging lens system 11 and the capturing element 12.

The first lens L1 is a glass lens having negative power. An object-side surface S1 of the first lens L1 has a spherical shape with a convex surface facing the object side. An image-side surface S2 of the first lens L1 has a spherical shape with a concave surface facing the image side.

The second lens L2 is a plastic lens having negative power. An object-side surface S3 of the second lens L2 has an aspherical surface shape having an inflection point. Specifically, the object-side surface S3 of the second lens L2 has a shape in which a concave surface faces the object side in a central part and a convex surface faces the object side in a peripheral part. An image-side surface S4 of the second lens L2 has an aspherical surface shape with a concave surface facing the image side.

The third lens L3 is a plastic lens having positive power. An object-side surface S5 of the third lens L3 has an aspherical surface shape with a concave surface facing the object side. An image-side surface S6 of the third lens L3 has an aspherical surface shape with a convex surface facing the image side.

The iris STOP is an iris that determines an f-number (F number, Fno) of a lens system. The iris STOP is arranged between the third lens L3 and the fourth lens L4.

The fourth lens L4 is a glass lens having positive power. An object-side surface S9 of the fourth lens L4 has a spherical shape with a convex surface facing the object side. An image-side surface S10 of the fourth lens L4 has a spherical shape with a convex surface facing the image side.

The fifth lens L5 is a plastic lens having negative power. An object-side surface S11 of the fifth lens L5 has an aspherical shape with a convex surface facing the object side. An image-side surface S12 of the fifth lens L5 has an aspherical shape with a concave surface facing the image side.

The sixth lens L6 is a plastic lens having positive power. An object-side surface S13 of the sixth lens L6 has an aspherical surface shape with a convex surface facing the object side. An image-side surface S14 of the sixth lens L6 has an aspherical surface shape with a convex surface facing the image side.

The fifth lens L5 and the sixth lens L6 constitute a cemented lens. That is, the image-side surface S12 of the fifth lens L5 and the object-side surface S13 of the sixth lens L6 are in contact with each other. The fifth lens L5 and the sixth lens L6 are bonded by an adhesive layer having a thickness of 0.020 mm on the axis.

The infrared cut filter (IRCF) is a filter for cutting light in the infrared region. When the imaging lens system 11 is designed, the imaging lens system 11 and the infrared cut filter are handled as one integrated component. However, the infrared cut filter is not an essential component of the imaging lens system 11. The infrared cut filter is disposed on the image side of the sixth lens L6.

A sensor cover glass for preventing adhesion of dust to the capturing element 12 may be arranged between the infrared cut filter and the capturing element 12.

Table 1 shows lens data of each lens surface in the imaging lens system 11 according to Example 1. Table 1 shows, as the lens data, a curvature radius (mm), a thickness (mm) between surfaces on the central optical axis, effective diameter (mm), a refractive index nd for a d-line, and an Abbe's number νd for the d-line, of each surface. In Table 1, surfaces marked with “*” are aspherical surfaces.

TABLE 1

| | Curvature | | Effective | | |
|---|---|---|---|---|---|
| Surface | Radius | Thickness | diameter | | |
| Number | (mm) | (mm) | (mm) | nd | νd |
| S1 | 10.259 | 1.000 | 5.615 | 1.840 | 42.722 |
| S2 | 2.957 | 2.326 | 2.810 | | |
| S3 * | −7.470 | 0.772 | 2.590 | 1.539 | 56.368 |
| S4 * | 6.942 | 0.916 | 1.650 | | |
| S5 * | −3.275 | 1.589 | 1.600 | 1.668 | 20.376 |
| S6 * | −2.678 | 0.601 | 1.719 | | |
| S7 (STOP) | INF | 0.028 | 1.219 | | |
| S8 | INF | 0.611 | 1.227 | | |
| S9 | 7.470 | 1.126 | 1.646 | 1.595 | 68.624 |
| S10 | −4.180 | 0.494 | 1.758 | | |
| S11 * | 14.615 | 0.700 | 1.800 | 1.641 | 23.965 |
| S12 * | 1.633 | 0.020 | 1.912 | | |
| S13 * | 1.633 | 3.598 | 1.925 | 1.539 | 56.368 |
| S14 * | −5.348 | 0.177 | 2.237 | | |
| S15 | INF | 0.300 | 2.371 | 1.517 | 64.198 |
| S16 | INF | 1.317 | 2.481 | | |
| S17 | INF | 0.400 | 2.791 | 1.517 | 64.198 |
| S18 | INF | 0.130 | 2.863 | | |

The aspherical surface shape adopted for the lens surface is expressed by the below-shown expression, in which z is a sag; c is the inverse of the curvature radius; k is a conic constant; r is a height of a ray from an optical axis OA; and α₄, α₆, α₈, α₁₀, α₁₂, α₁₄, and α₁₆ are 4th, 6th, 8th, 10th, 12th, 14th, and 16th order aspherical surface coefficients, respectively.

$$z = \frac{{cr}^{2}}{1 + \sqrt{1 - ( 1 + k ) {c}^{2} {r}^{2}}} + {α}_{4} {r}^{4} + {α}_{6} {r}^{6} + {α}_{8} {r}^{8} + {α}_{10} {r}^{10} + {α}_{12} {r}^{12} + {α}_{14} {r}^{14} + {α}_{16} {r}^{16} \qquad [ Expression 1 ]$$

Table 2 shows aspherical surface coefficients for defining aspherical surface shapes of aspherical lens surfaces in the imaging lens system 11 according to Example 1. Note that, in Table 2, for example, “−2.843E-03” means “−2.843×10⁻³”. The above-described numerical explanations apply to other tables shown later.

TABLE 2

| | k | α₄ | α₆ | α₈ |
|---|---|---|---|---|
| Lens Surface S3 | 0.000 | 3.852E−03 | 5.748E−04 | −2.877E−05 |
| Lens Surface S4 | 15.871 | −2.843E−03 | 3.386E−04 | 2.581E−04 |
| Lens Surface S5 | 0.000 | −2.153E−02 | 2.820E−03 | −1.129E−05 |
| Lens Surface S6 | 0.000 | 1.390E−03 | 1.677E−03 | −1.432E−04 |
| Lens Surface S11 | 0.000 | 3.019E−03 | −1.962E−03 | 1.806E−04 |
| Lens Surface S12 | −0.750 | 5.034E−02 | −2.241E−02 | 6.551E−03 |
| Lens Surface S13 | −0.750 | 5.134E−02 | −2.241E−02 | 6.551E−03 |
| Lens Surface S14 | 0.636 | 8.603E−03 | −2.582E−03 | 1.160E−03 |
| | α₁₀ | α₁₂ | α₁₄ | α₁₆ |
| Lens Surface S3 | 0.000E+00 | 0.000E+00 | 0.000E+00 | 0.000E+00 |
| Lens Surface S4 | 0.000E+00 | 0.000E+00 | 0.000E+00 | 0.000E+00 |
| Lens Surface S5 | 0.000E+00 | 0.000E+00 | 0.000E+00 | 0.000E+00 |
| Lens Surface S6 | 0.000E+00 | 0.000E+00 | 0.000E+00 | 0.000E+00 |
| Lens Surface S11 | 0.000E+00 | 0.000E+00 | 0.000E+00 | 0.000E+00 |
| Lens Surface S12 | −1.253E−03 | 1.044E−04 | 0.000E+00 | 0.000E+00 |
| Lens Surface S13 | −1.253E−03 | 1.044E−04 | 0.000E+00 | 0.000E+00 |
| Lens Surface S14 | −2.326E−04 | 1.971E−05 | 0.000E+00 | 0.000E+00 |

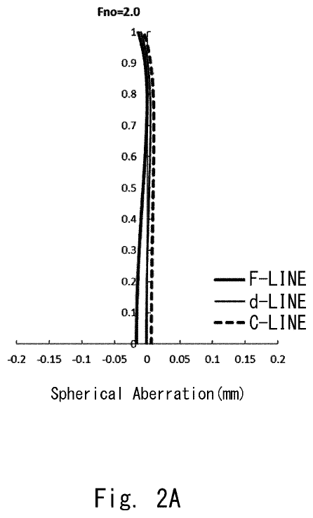

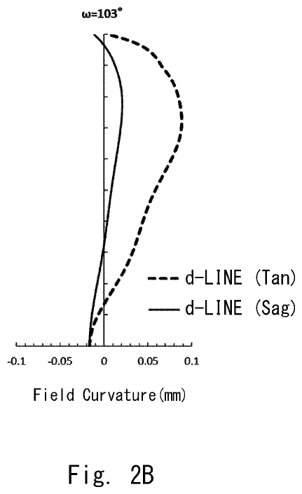

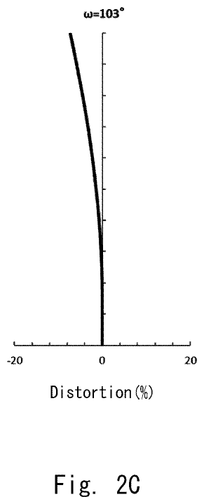

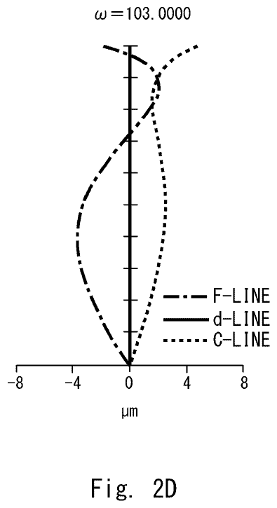

Next, an aberration will be described with reference to the drawings. FIG. 2A to FIG. 2D show a spherical aberration diagram (longitudinal aberration diagram), a field curvature diagram, a distortion diagram, and a lateral color aberration in the imaging lens system 11 according to Example 1. As shown in FIG. 2A to FIG. 2D, in the imaging lens system 11 of Example 1, the F Number is 2.0 and the half angle of view is 103°.

In the longitudinal aberration diagram of FIG. 2A, the horizontal axis indicates positions at which the ray intersects the optical axis OA, and the vertical axis indicates passing heights of rays on the incident pupil. Furthermore, FIG. 2A shows results of simulations by a d-line, a C-line, and an F-line.

In the field curvature diagram of FIG. 2B, the horizontal axis indicates distances in the direction of the optical axis OA, and the vertical axis indicates image heights (angle of view). In the field curvature diagram of FIG. 2B, Sag indicates the imaging position in the sagittal ray, and Tan indicates the imaging position in the tangential ray. FIG. 2B shows a result of simulation by the d-line.

In the distortion diagram of FIG. 2C, the horizontal axis indicates distortion (%) of an image, and the vertical axis indicates image heights (angle of view). FIG. 2C shows a result of simulation by a ray of the d-line.

In the lateral color aberration diagram of FIG. 2D, the horizontal axis indicates amounts of the lateral color aberration, and the vertical axis indicates image heights (angle of view). FIG. 2D shows results of simulations by the d-line, the C-line, and the F-line.

### Example 2

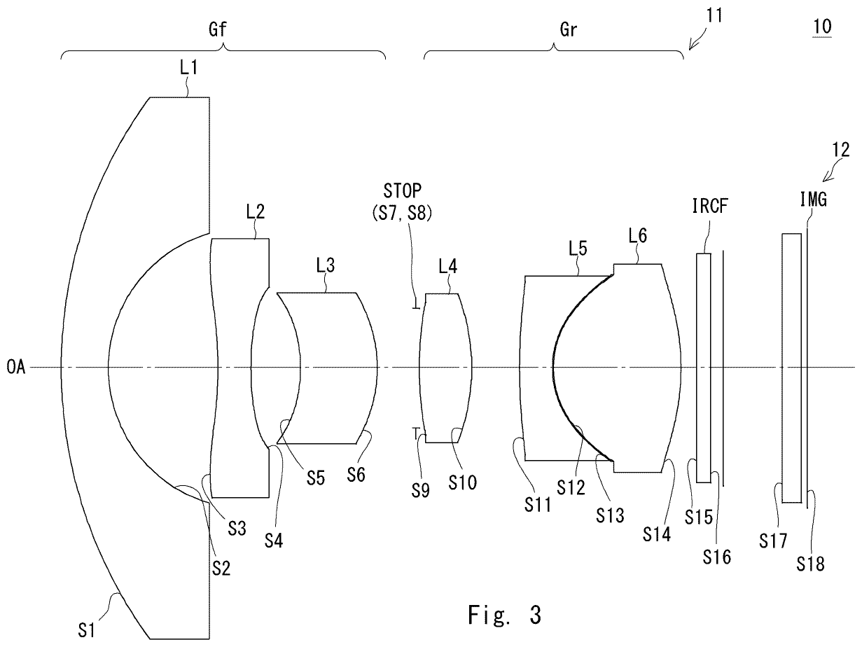

FIG. 3 is a cross-sectional view showing the camera module 10 according to Example 2. Since the imaging lens system 11 according to Example 2 has the same lens configuration as that of Example 1, descriptions thereof will be omitted. Hereinafter, property data of the imaging lens system 11 according to Example 2 will be described.

Table 3 shows lens data of each lens surface in the imaging lens system 11 according to Example 2. Since the items shown in Table 3 are the same as those in Table 1, descriptions thereof are omitted.

TABLE 3

| | Curvature | | Effective | | |
|---|---|---|---|---|---|
| Surface | Radius | Thickness | diameter | | |
| Number | (mm) | (mm) | (mm) | nd | νd |
| S1 | 9.704 | 1.000 | 5.738 | 1.839 | 42.722 |
| S2 | 2.976 | 2.326 | 2.855 | | |
| S3 * | −7.298 | 0.700 | 2.740 | 1.539 | 56.368 |
| S4 * | 7.026 | 1.048 | 1.716 | | |
| S5 * | −3.252 | 1.630 | 1.579 | 1.668 | 20.376 |
| S6 * | −2.935 | 0.813 | 1.600 | | |
| S7 (STOP) | INF | 0.028 | 1.269 | | |
| S8 | INF | 0.048 | 1.287 | | |
| S9 | 7.412 | 1.111 | 1.399 | 1.595 | 68.624 |
| S10 | −4.357 | 1.017 | 1.575 | | |
| S11 * | 13.774 | 0.700 | 1.835 | 1.668 | 20.376 |
| S12 * | 2.103 | 0.020 | 1.957 | | |
| S13 * | 2.103 | 2.705 | 1.977 | 1.539 | 56.368 |
| S14 * | −4.745 | 0.325 | 2.204 | | |
| S15 | INF | 0.300 | 2.381 | 1.517 | 64.198 |
| S16 | INF | 1.522 | 2.492 | | |
| S17 | INF | 0.400 | 2.791 | 1.517 | 64.198 |
| S18 | INF | 0.130 | 2.853 | | |

Table 4 shows aspherical surface coefficients for defining aspherical surface shapes of aspherical lens surfaces in the imaging lens system 11 according to Example 2. In Table 4, the aspherical surface shape adopted for the lens surface is expressed by an expression similar to that in Example 1.

TABLE 4

| | k | α₄ | α₆ | α₈ |
|---|---|---|---|---|
| Lens Surface S3 | 0.000 | 7.406E−03 | 2.463E−05 | −1.011E−05 |
| Lens Surface S4 | 13.433 | 2.039E−03 | 3.284E−03 | −1.247E−03 |
| Lens Surface S5 | 0.000 | −1.789E−02 | 1.192E−03 | 2.831E−04 |
| Lens Surface S6 | 0.000 | 4.802E−04 | 1.244E−03 | −1.202E−04 |
| Lens Surface S11 | 0.000 | 4.001E−03 | −2.442E−03 | 3.133E−04 |
| Lens Surface S12 | −0.528 | 4.855E−02 | −2.245E−02 | 6.632E−03 |
| Lens Surface S13 | −0.528 | 4.955E−02 | −2.245E−02 | 6.632E−03 |
| Lens Surface S14 | 1.406 | 7.425E−03 | −1.810E−03 | 8.756E−04 |
| | α₁₀ | α₁₂ | α₁₄ | α₁₆ |
| Lens Surface S3 | 5.038E−07 | 8.185E−09 | −8.240E−11 | 0.000E+00 |
| Lens Surface S4 | 3.086E−04 | 5.280E−08 | 0.000E+00 | 0.000E+00 |
| Lens Surface S5 | −5.453E−05 | 0.000E+00 | 0.000E+00 | 0.000E+00 |
| Lens Surface S6 | 2.168E−05 | 0.000E+00 | 0.000E+00 | 0.000E+00 |
| Lens Surface S11 | 0.000E+00 | 0.000E+00 | 0.000E+00 | 0.000E+00 |
| Lens Surface S12 | −1.273E−03 | 1.263E−04 | −2.229E−06 | 0.000E+00 |
| Lens Surface S13 | −1.273E−03 | 1.263E−04 | −2.229E−06 | 0.000E+00 |
| Lens Surface S14 | −1.590E−04 | 1.123E−05 | 2.416E−07 | 0.000E+00 |

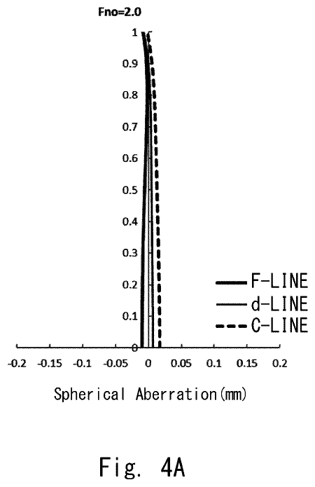

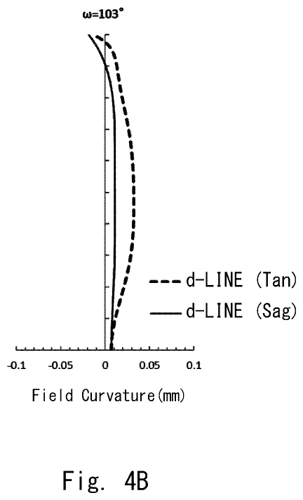

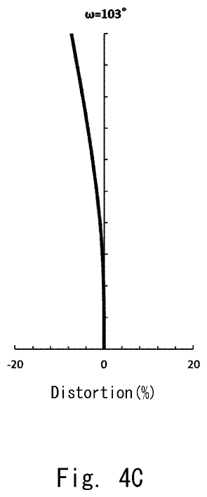

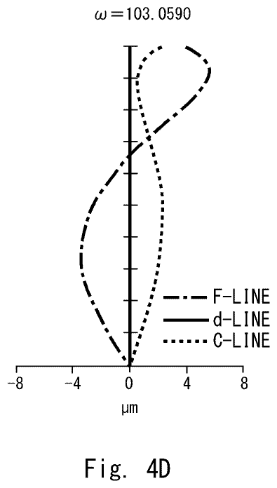

FIG. 4A to FIG. 4D show a spherical aberration diagram (longitudinal aberration diagram), a field curvature diagram, a distortion diagram, and a lateral color aberration diagram in the imaging lens system 11 of Example 2. Since the description of each aberration diagram shown in FIG. 4A to FIG. 4D is the same as that of FIG. 2A to FIG. 2D, descriptions thereof will be omitted.

### Example 3

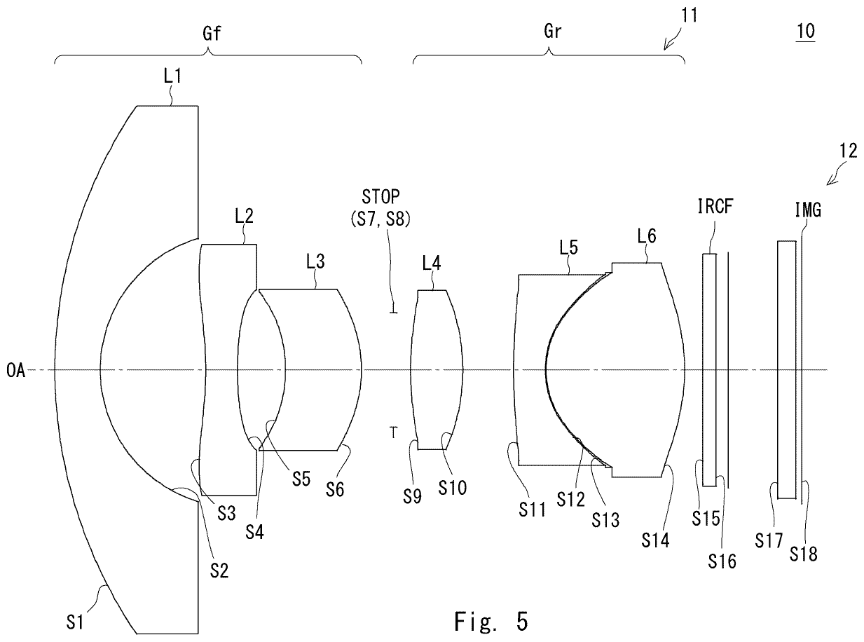

FIG. 5 is a cross-sectional view showing the camera module 10 according to Example 3. Since the imaging lens system 11 according to Example 3 has the same lens configuration as that of Example 1, the description thereof will be omitted. Hereinafter, property data of the imaging lens system 11 according to Example 3 will be described.

Table 5 shows lens data of each lens surface in the imaging lens system 11 according to Example 3. Since the items shown in Table 5 are the same as those in Table 1, descriptions thereof are omitted.

TABLE 5

| | Curvature | | Effective | | |
|---|---|---|---|---|---|
| Surface | Radius | Thickness | diameter | | |
| Number | (mm) | (mm) | (mm) | nd | νd |
| S1 | 10.290 | 1.000 | 5.813 | 1.839 | 42.722 |
| S2 | 3.019 | 2.326 | 2.894 | | |
| S3 * | −7.381 | 0.700 | 2.766 | 1.539 | 56.368 |
| S4 * | 7.878 | 1.058 | 1.766 | | |
| S5 * | −3.201 | 1.676 | 1.718 | 1.668 | 20.376 |
| S6 * | −2.989 | 0.704 | 1.772 | | |
| S7 (STOP) | INF | 0.028 | 1.259 | | |
| S8 | INF | 0.358 | 1.276 | | |
| S9 | 8.165 | 1.148 | 1.598 | 1.595 | 68.624 |
| S10 | −4.324 | 1.119 | 1.755 | | |
| S11 * | 13.777 | 0.700 | 1.992 | 1.668 | 20.376 |
| S12 * | 2.160 | 0.020 | 2.104 | | |
| S13 * | 2.160 | 3.050 | 2.146 | 1.539 | 56.368 |
| S14 * | −4.430 | 0.397 | 2.359 | | |
| S15 | INF | 0.300 | 2.518 | 1.517 | 64.198 |
| S16 | INF | 1.355 | 2.600 | | |
| S17 | INF | 0.400 | 2.790 | 1.517 | 64.198 |
| S18 | INF | 0.130 | 2.836 | | |

Table 6 shows aspherical surface coefficients for defining aspherical surface shapes of aspherical lens surfaces in the imaging lens system 11 of Example 3. In Table 6, the aspherical surface shape adopted for the lens surface is expressed by an expression similar to that in Example 1.

TABLE 6

| | k | α₄ | α₆ | α₈ |
|---|---|---|---|---|
| Lens Surface S3 | 0.000 | 8.658.E−03 | −5.792.E−05 | −2.095.E−05 |
| Lens Surface S4 | 17.480 | 3.714.E−03 | 3.144.E−03 | −1.028.E−03 |
| Lens Surface S5 | 0.000 | −1.417.E−02 | 1.736.E−03 | 2.727.E−04 |
| Lens Surface S6 | 0.000 | 1.049.E−03 | 1.527.E−03 | −2.179.E−04 |
| Lens Surface S11 | 0.000 | 3.601.E−03 | −2.549.E−03 | 2.955.E−04 |
| Lens Surface S12 | −0.525 | 4.806.E−02 | −2.181.E−02 | 5.834.E−03 |
| Lens Surface S13 | −0.525 | 5.106.E−02 | −2.181.E−02 | 5.834.E−03 |
| Lens Surface S14 | 1.931 | 8.563.E−03 | −1.785.E−03 | 8.627.E−04 |
| | α₁₀ | α₁₂ | α₁₄ | α₁₆ |
| Lens Surface S3 | 9.016.E−07 | 1.984.E−07 | −1.524.E−08 | 0.000.E+00 |
| Lens Surface S4 | 2.521.E−04 | −7.920.E−06 | 0.000.E+00 | 0.000.E+00 |
| Lens Surface S5 | −9.299.E−05 | 9.812.E−06 | 0.000.E+00 | 0.000.E+00 |
| Lens Surface S6 | 2.727.E−05 | 4.926.E−07 | 0.000.E+00 | 0.000.E+00 |
| Lens Surface S11 | 0.000.E+00 | 0.000.E+00 | 0.000.E+00 | 0.000.E+00 |
| Lens Surface S12 | −1.217.E−03 | 1.479.E−04 | −5.646.E−06 | 0.000.E+00 |
| Lens Surface S13 | −1.217.E−03 | 1.479.E−04 | −5.646.E−06 | 0.000.E+00 |
| Lens Surface S14 | −1.459.E−04 | 1.268.E−05 | −2.869.E−08 | 0.000.E+00 |

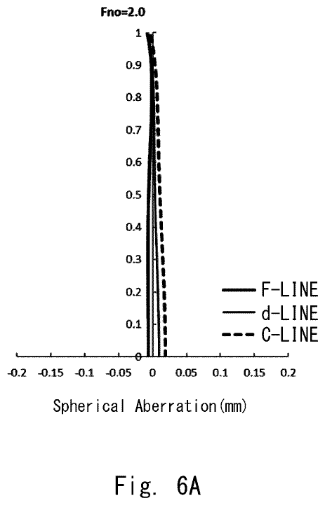

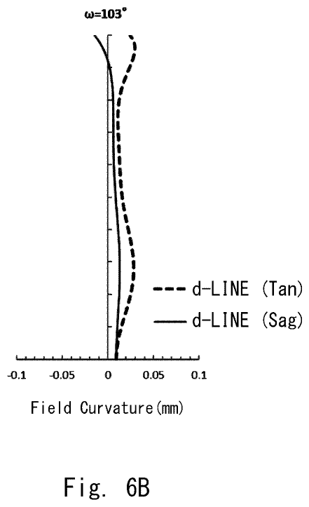

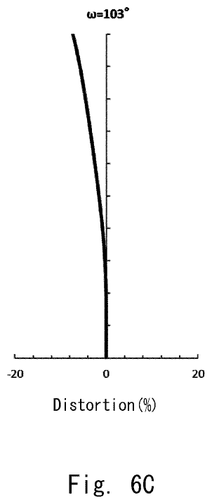

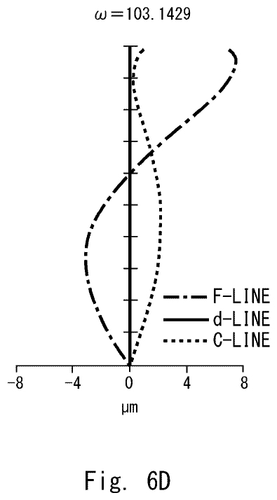

FIG. 6A to FIG. 6D show a spherical aberration diagram (longitudinal aberration diagram), a field curvature diagram, a distortion diagram, and a lateral color aberration diagram in the imaging lens system 11 of Example 3. Since the description of each aberration diagram shown in FIG. 6A to FIG. 6D is the same as that of FIG. 2A to FIG. 2D, the description thereof will be omitted.

### Example 4

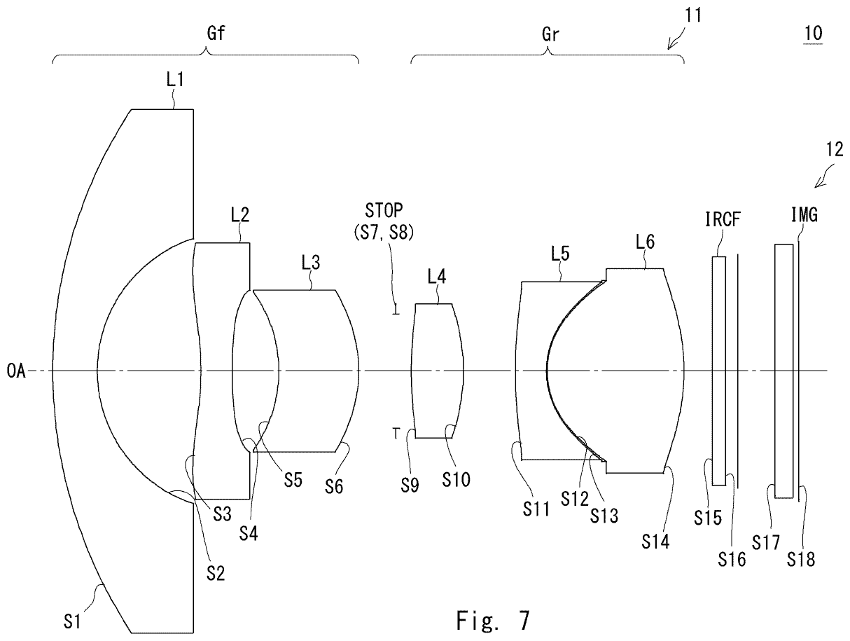

FIG. 7 is a cross-sectional view showing the camera module 10 according to Example 4. Since the imaging lens system 11 according to Example 4 has the same lens configuration as that of Example 1, descriptions thereof will be omitted. Hereinafter, property data of the imaging lens system 11 according to Example 4 will be described.

Table 7 shows lens data of each lens surface in the imaging lens system 11 according to Example 4. Since the items shown in Table 7 are the same as those in Table 1, descriptions thereof are omitted.

TABLE 7

| | Curvature | | Effective | | |
|---|---|---|---|---|---|
| Surface | Radius | Thickness | diameter | | |
| Number | (mm) | (mm) | (mm) | nd | νd |
| S1 | 10.618 | 1.000 | 5.865 | 1.840 | 42.728 |
| S2 | 3.119 | 2.326 | 2.967 | | |
| S3 * | −6.343 | 0.700 | 2.878 | 1.539 | 56.368 |
| S4 * | 11.105 | 1.045 | 1.820 | | |
| S5 * | −3.346 | 1.798 | 1.779 | 1.668 | 20.376 |
| S6 * | −3.145 | 0.837 | 1.818 | | |
| S7 (STOP) | INF | 0.028 | 1.278 | | |
| S8 | INF | 0.317 | 1.281 | | |
| S9 | 9.839 | 1.165 | 1.324 | 1.620 | 63.406 |
| S10 | −4.455 | 1.167 | 1.500 | | |
| S11 * | 10.977 | 0.700 | 1.850 | 1.668 | 20.376 |
| S12 * | 1.998 | 0.020 | 1.997 | | |
| S13 * | 1.998 | 3.067 | 2.026 | 1.539 | 56.368 |
| S14 * | −4.711 | 0.637 | 2.292 | | |
| S15 | INF | 0.300 | 2.520 | 1.517 | 64.198 |
| S16 | INF | 1.109 | 2.617 | | |
| S17 | INF | 0.400 | 2.791 | 1.517 | 64.198 |
| S18 | INF | 0.130 | 2.845 | | |

Table 8 shows aspherical surface coefficients for defining aspherical surface shapes of aspherical lens surfaces in the imaging lens system 11 of Example 4. In Table 8, the aspherical surface shape adopted for the lens surface is expressed by an expression similar to that in Example 1.

TABLE 8

| | k | α₄ | α₆ | α₈ |
|---|---|---|---|---|
| Lens Surface S3 | 0.000 | 8.875.E−03 | 1.515.E−04 | −4.084.E−05 |
| Lens Surface S4 | 35.853 | 5.677.E−03 | 1.253.E−03 | 1.704.E−04 |
| Lens Surface S5 | 0.000 | −1.267.E−02 | 1.460.E−03 | 6.693.E−04 |
| Lens Surface S6 | 0.000 | 1.376.E−03 | 1.757.E−03 | −4.855.E−04 |
| Lens Surface S11 | 0.000 | 2.717.E−03 | −1.791.E−03 | 2.010.E−04 |
| Lens Surface S12 | −0.509 | 3.444.E−02 | −1.320.E−02 | 2.911.E−03 |
| Lens Surface S13 | −0.509 | 3.744.E−02 | −1.320.E−02 | 2.911.E−03 |
| Lens Surface S14 | 2.034 | 7.543.E−03 | −1.578.E−03 | 7.097.E−04 |
| | α₁₀ | α₁₂ | α₁₄ | α₁₆ |
| Lens Surface S3 | −7.588.E−07 | 5.511.E−07 | −2.786.E−08 | 0.000.E+00 |
| Lens Surface S4 | −4.289.E−05 | 1.167.E−05 | 0.000.E+00 | 0.000.E+00 |
| Lens Surface S5 | −2.982.E−04 | 4.916.E−05 | 0.000.E+00 | 0.000.E+00 |
| Lens Surface S6 | 1.240.E−04 | −1.213.E−05 | 0.000.E+00 | 0.000.E+00 |
| Lens Surface S11 | −1.214.E−05 | 2.270.E−06 | 0.000.E+00 | 0.000.E+00 |
| Lens Surface S12 | −8.012.E−04 | 1.593.E−04 | −1.294.E−05 | 0.000.E+00 |
| Lens Surface S13 | −8.012.E−04 | 1.593.E−04 | −1.294.E−05 | 0.000.E+00 |
| Lens Surface S14 | −1.081.E−04 | 7.424.E−06 | 1.855.E−07 | 0.000.E+00 |

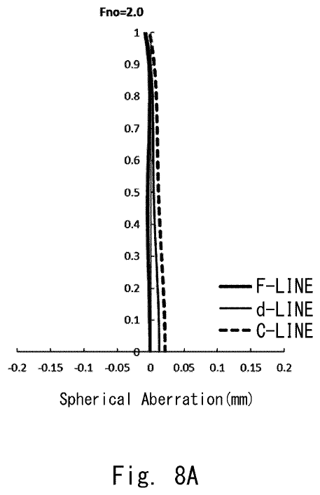

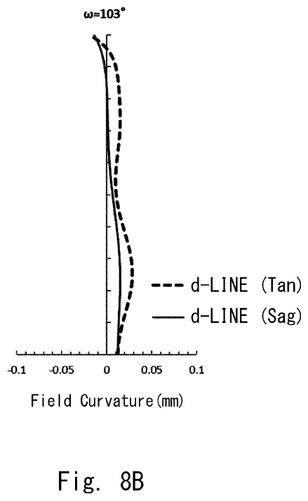

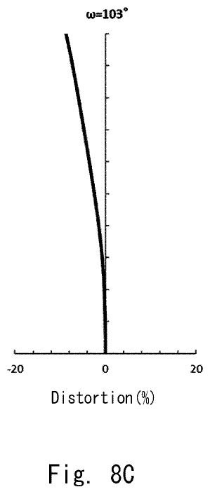

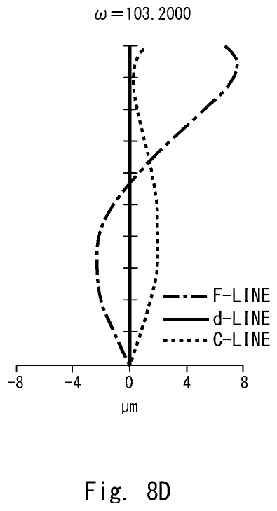

FIG. 8A to FIG. 8D show a spherical aberration diagram (longitudinal aberration diagram), a field curvature diagram, a distortion diagram, and a lateral color aberration diagram in the imaging lens system 11 of Example 4. Since the description of each aberration diagram shown in FIG. 8A to FIG. 8D is the same as that of FIG. 2A to FIG. 2D, descriptions thereof are omitted.

### Example 5

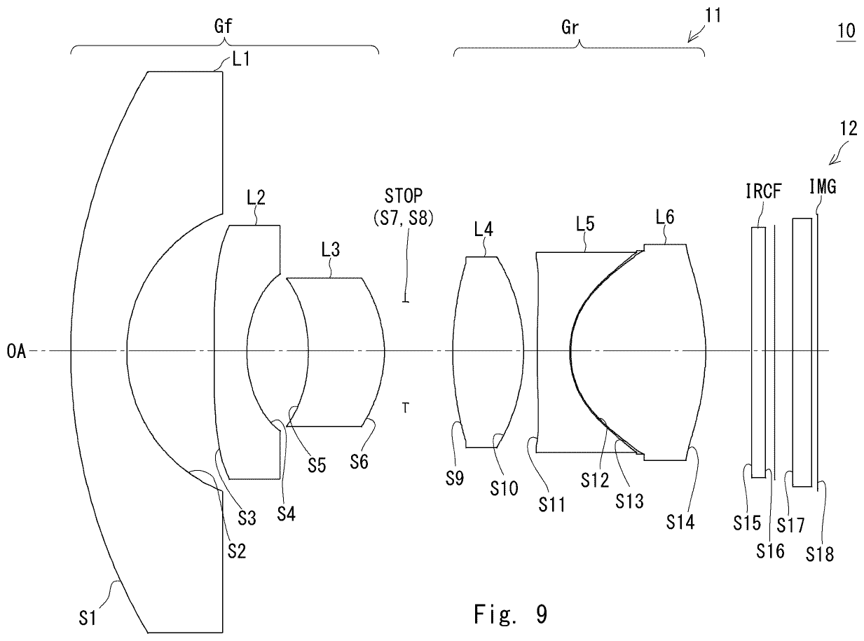

FIG. 9 is a cross-sectional view showing the camera module 10 according to Example 5. The imaging lens system 11 according to Example 5 differs from Example 1 in that the object-side surface S3 of the second lens L2 has a convex shape on the object side. Since other configurations of the imaging lens system 11 according to Example 5 have the same lens configuration as that of Example 1, descriptions thereof are omitted. Hereinafter, property data of the imaging lens system 11 according to Example 5 will be described.

Table 9 shows lens data of each lens surface in the imaging lens system 11 according to Example 5. Since the items shown in Table 9 are the same as those in Table 1, descriptions thereof are omitted.

TABLE 9

| | Curvature | | Effective | | |
|---|---|---|---|---|---|
| Surface | Radius | Thickness | diameter | | |
| Number | (mm) | (mm) | (mm) | nd | νd |
| S1 | 11.758 | 1.200 | 6.000 | 1.839 | 42.728 |
| S2 | 3.167 | 1.874 | 2.964 | | |
| S3 * | 115.123 | 0.700 | 2.719 | 1.539 | 56.368 |
| S4 * | 2.729 | 1.319 | 1.679 | | |
| S5 * | −3.549 | 1.626 | 1.572 | 1.668 | 20.376 |
| S6 * | −2.740 | 0.446 | 1.587 | | |
| S7 (STOP) | INF | 0.028 | 1.080 | | |
| S8 | INF | 0.996 | 1.097 | | |
| S9 | 6.724 | 1.516 | 1.908 | 1.620 | 63.406 |
| S10 | −3.899 | 0.291 | 2.041 | | |
| S11 * | 25.944 | 0.700 | 2.008 | 1.668 | 20.376 |
| S12 | 2.203 | 0.020 | 2.143 | | |
| S13 * | 2.203 | 2.887 | 2.178 | 1.539 | 56.368 |
| S14 * | −5.004 | 0.981 | 2.314 | | |
| S15 | INF | 0.300 | 2.634 | 1.517 | 64.198 |
| S16 | INF | 0.592 | 2.724 | | |
| S17 | INF | 0.400 | 2.815 | 1.517 | 64.198 |
| S18 | INF | 0.125 | 2.875 | | |

Table 10 shows aspherical surface coefficients for defining aspherical surface shapes of aspherical lens surfaces in the imaging lens system 11 of Example 5. In Table 10, the aspherical surface shape adopted for the lens surface is expressed by an expression similar to that in Example 1.

TABLE 10

| | k | α₄ | α₆ | α₈ |
|---|---|---|---|---|
| Lens Surface S3 | 0.000 | 6.144.E−03 | −3.704.E−04 | 4.449.E−05 |
| Lens Surface S4 | 1.041 | 1.956.E−03 | −3.789.E−03 | 3.982.E−03 |
| Lens Surface S5 | 0.000 | −1.742.E−02 | 1.134.E−05 | 9.424.E−04 |
| Lens Surface S6 | 0.000 | −3.194.E−04 | 2.989.E−03 | −1.212.E−03 |
| Lens Surface S11 | 0.000 | 1.172.E−03 | −2.383.E−03 | 2.229.E−04 |
| Lens Surface S12 | −0.008 | 4.650.E−02 | −2.129.E−02 | 7.526.E−03 |
| Lens Surface S13 | −0.008 | 4.950.E−02 | −2.129.E−02 | 7.526.E−03 |
| Lens Surface S14 | 1.198 | 7.399.E−03 | −2.659.E−03 | 1.288.E−03 |
| | α₁₀ | α₁₂ | α₁₄ | α₁₆ |
| Lens Surface S3 | −3.615.E−06 | 4.405.E−07 | −1.404.E−08 | 0.000.E+00 |
| Lens Surface S4 | −1.908.E−03 | 3.378.E−04 | 0.000.E+00 | 0.000.E+00 |
| Lens Surface S5 | −3.688.E−04 | 4.843.E−05 | 0.000.E+00 | 0.000.E+00 |
| Lens Surface S6 | 3.230.E−04 | −3.357.E−05 | 0.000.E+00 | 0.000.E+00 |
| Lens Surface S11 | −1.607.E−05 | −7.994.E−07 | 0.000.E+00 | 0.000.E+00 |
| Lens Surface S12 | −2.680.E−03 | 5.368.E−04 | −4.806.E−05 | 0.000.E+00 |
| Lens Surface S13 | −2.680.E−03 | 5.368.E−04 | −4.806.E−05 | 0.000.E+00 |
| Lens Surface S14 | −2.957.E−04 | 3.181.E−05 | −8.650.E−07 | 0.000.E+00 |

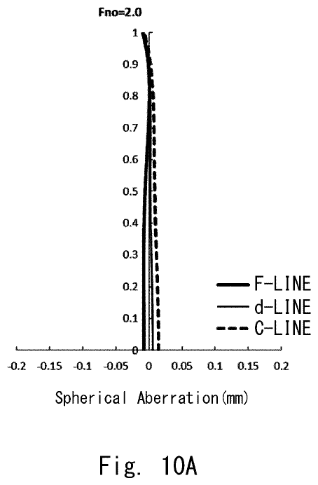

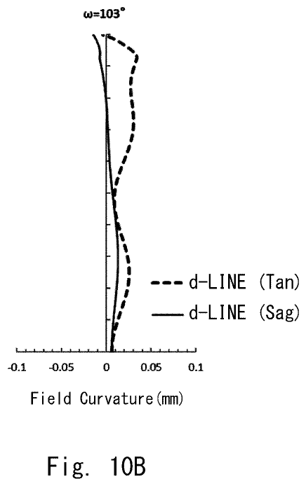

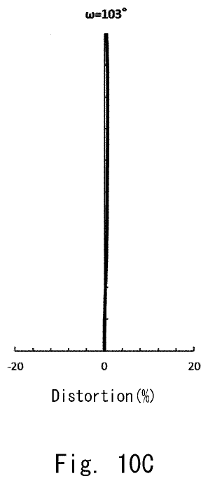

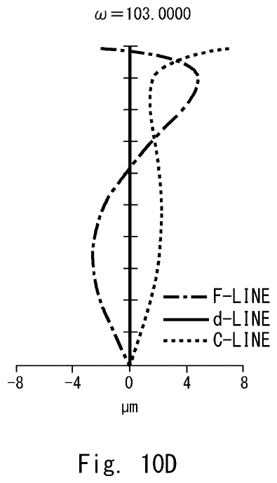

FIG. 10A to FIG. 10D show a spherical aberration diagram (longitudinal aberration diagram), a field curvature diagram, a distortion diagram, and a lateral color aberration diagram in the imaging lens system 11 of Example 5. Since the description of each aberration diagram shown in FIG. 1A to FIG. 10D is the same as that of FIG. 2A to FIG. 2D, descriptions thereof are omitted.

Table 11 shows a total track length TTL of the imaging lens system 11, a focal length f of an entire optical system of the imaging lens system 1, a focal length f1 of the first lens L1, a focal length f2 of the second lens L2, a focal length f3 of the third lens L3, a focal length f4 of the fourth lens L4, a focal length f5 of the fifth lens L5, a focal length f6 of the sixth lens L6, a value of f1/f, a value of f2/f, a value of f3/f, a value of f4/f, a value of f5/f, a value of f6/f, a value of TTL/f, a d-line refractive index nd1 of the first lens L1, and an Abbe's number νd4 of a d-line of the fourth lens. In Table 11, the units of the focal length and the total track length are both mm. The focal length and the total length shown in Table 11 are calculated using a wavelength ray of 550 nm.

TABLE 11

| | Example | Example | Example | Example | Example |
|---|---|---|---|---|---|
| | 1 | 2 | 3 | 4 | 5 |
| Total track | 16.105 | 15.823 | 16.469 | 16.746 | 16.001 |
| length TTL | | | | | |
| Entire system | 1.727 | 1.727 | 1.724 | 1.751 | 1.503 |
| focal length f | | | | | |
| f1 | −5.279 | −5.485 | −5.432 | −5.602 | −5.519 |
| f2 | −6.555 | −6.533 | −6.961 | −7.389 | −5.202 |
| f3 | 10.636 | 14.735 | 16.195 | 17.100 | 9.976 |
| f4 | 4.674 | 4.781 | 4.921 | 5.103 | 4.210 |
| f5 | −25.302 | −34.703 | −37.346 | −49.824 | −20.591 |
| f6 | 8.488 | 7.847 | 7.439 | 7.785 | 8.276 |
| f1/f | −3.057 | −3.176 | −3.151 | −3.199 | −3.671 |
| f2/f | −3.796 | −3.782 | −4.038 | −4.220 | −3.460 |
| f3/f | 6.159 | 8.530 | 9.394 | 9.765 | 6.637 |
| f4/f | 2.707 | 2.768 | 2.854 | 2.914 | 2.801 |
| f5/f | −14.652 | −20.090 | −21.663 | −28.453 | −13.699 |
| f6/f | 4.915 | 4.543 | 4.315 | 4.446 | 5.506 |
| TTL/f | 9.326 | 9.160 | 9.553 | 9.563 | 10.645 |
| nd1 | 1.840 | 1.839 | 1.839 | 1.840 | 1.839 |
| νd4 | 68.624 | 68.624 | 68.624 | 63.406 | 63.406 |

In Examples 1 to 5, with the power of the first lens L1 being relatively strong such that the Conditional Expression (1) is satisfied, a smaller aperture of the first lens L1 can be achieved, and the optical system can be downsized. Specifically, since the value of f1/f is smaller than −3.0, the aperture of the first lens can be made small, and the imaging lens system can be certainly downsized. Since the value of f1/f is greater than −5.0, the lateral color aberration generated in the first lens L1 is suppressed to an optimal range, and worsening of the imaging performance of the imaging lens system 11 can be avoided. In fact, as shown in FIG. 2D, FIG. 4D, FIG. 6D, FIG. 8D, and FIG. 10D, in Examples 1 to 5, lateral color aberrations are optimally reduced.

With the power of the fourth lens L4 satisfying the Conditional Expression (2), a high resolution can be achieved more certainly. Specifically, since the value of f4/f is greater than 2.7, an increase in error sensitivity of the imaging performance can be prevented, and easier occurrence of a manufacturing error can be avoided. Moreover, since the value of f4/f is less than 3.1, an increase in the total length of the optical system can be avoided, and the imaging lens system 11 can certainly be downsized.

With the Abbe's number νd4 of the fourth lens L4 satisfying the Conditional Expression (3), the lateral color aberration generated in the first lens L1 can be corrected, and a high resolution can be achieved. In fact, as shown in FIG. 2D, FIG. 4D, FIG. 6D, FIG. 8D, and FIG. 10D, in Examples 1 to 5, lateral color aberrations are optimally reduced.

With the power of the third lens L3 satisfying the Conditional Expression (4), a distance from the incident pupil to the iris can be shortened, and the optical system can be downsized. Specifically, since the value of f3/f is less than 10.0, a space between the first lens L1 and the iris is prevented from being broadened, and a smaller aperture of the first lens L1 is achieved, resulting in downsizing of the imaging lens system 11. Moreover, since the value of f3/f is greater than 6.0, the lateral color aberration generated in the first lens L1 can be prevented from becoming too large, and worsening of the imaging performance of the imaging lens system 11 can be avoided. Thus, the imaging lens system 11, which can achieve a high resolution and is downsized, can be provided. In fact, in the imaging lens system 11 according to Examples 1 to 5, the aperture (effective diameter) of the first lens L1 is about nearly twice a diagonal length of the capturing element 12, and downsizing of the imaging lens system 11 is achieved. As shown in FIG. 2A to FIG. 2D, FIG. 4A to FIG. 4D, FIG. 6A to FIG. 6D, FIG. 8A to FIG. 8D, and FIG. 10A to FIG. 10D, the imaging lens system 11 according to Examples 1 to 5 optimally reduces spherical aberrations, field curvatures, distortions, and lateral color aberrations, and excellent imaging performance and a high resolution are achieved.

In Examples 1 to 5, the imaging lens system 11 satisfies the above Conditional Expression (5). Thus, the imaging lens system can certainly be downsized.

In Examples 1 to 5, the imaging lens system 11 satisfies the above Conditional Expression (6). Thus, color aberrations on the axis generated due to the fourth lens L4 can be optimally corrected. In fact, as shown in FIG. 2A to FIG. 2D, FIG. 4A to FIG. 4D, FIG. 6A to FIG. 6D, FIG. 8A to FIG. 8D, and FIG. 10A to FIG. 10D, the imaging lens system 11 according to Examples 1 to 5 optimally reduces spherical aberrations, field curvatures, and distortions, and excellent imaging performance and a high resolution are achieved.

In Examples 1 to 5, the imaging lens system 11 satisfies the above Conditional Expression (7). Thus, a smaller aperture of the first lens L1 can be achieved.

In Examples 1 to 5, the first lens L1 and the fourth lens L4 are glass lenses, and the second lens L2, the third lens L3, the fifth lens L5, and the sixth lens L6 are plastic lenses. With the first lens L1 being a glass lens, the imaging lens system 11 excellent in weather resistance can be provided. Moreover, with the fourth lens L4 being a glass lens, the imaging lens system 11 in which a focus shift due to an environmental temperature change is reduced can be provided. Table 12 shows a focus shift range (μm) in accordance with an environmental temperature change of the focal length f of the imaging lens system 11 in Examples 1 to 5. Table 12 shows a focus shift range from the focal length f at room temperature 25° C. The material of a barrel and a housing used for calculation of the focus shift range of the focal length f shown in Table 10 is RenyXL1027U manufactured by Mitsubishi Engineering-Plastics Corporation.

TABLE 12

Focus shift range (μm)

| Example | −40° C. | 25° C. | 105° C. | 120° C. |
|---|---|---|---|---|
| 1 | 2.2 | 0 | 1.8 | 2.2 |
| 2 | 1.1 | 0 | 6.1 | 7.2 |
| 3 | 1.3 | 0 | 4.0 | 5.0 |
| 4 | 3.3 | 0 | 2.9 | 3.4 |
| 5 | 8.6 | 0 | −7.8 | −7.9 |

With the second lens L2, the third lens L3, the fifth lens L5, and the sixth lens L6 being plastic lenses, the manufacturing cost can be reduced.

In Examples 1 to 5, the object-side surface S3 and the image-side surface S4 of the second lens L2 have aspherical surface shapes, and the object-side surface S3 of the second lens L2 has an inflection point. Thus, adjustment of the angle of view characteristic is facilitated, and a decrease in peripheral light quantity, which is an issue in a wide-angle imaging lens system, can be suppressed.

With the camera module 10 including the imaging lens system 11, and the imaging lens system 11 being downsized and having a sufficient resolution required for image recognition in autonomous driving, downsizing and precise sensing of the camera module 10 can be achieved.

### Third Embodiment

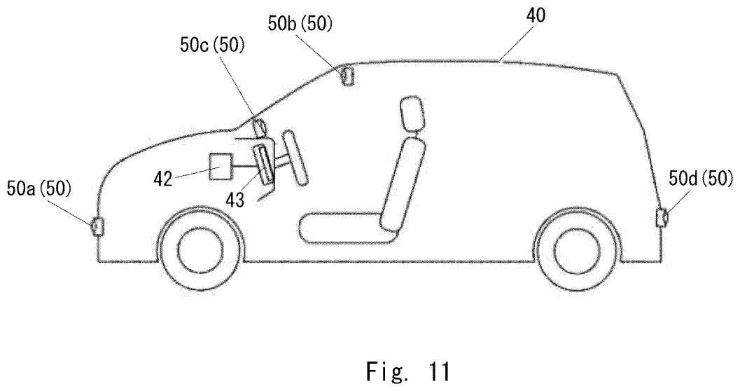

FIG. 11 is an overview diagram of a car 40 on which an in-vehicle system is mounted. The in-vehicle system includes capturing apparatuses 50 each including the imaging lens system 11 according to the first embodiment or second embodiment and a capturing element 12 for converting light converged therethrough into electrical signals. As shown in the drawing, the capturing apparatus 50 can be mounted on the car 40. FIG. 11 is an example arrangement exemplifying positions on the car 40 where the capturing apparatuses 50 are mounted. The capturing apparatuses 50 mounted on the car 40 may also be referred to as on-board cameras and may be installed at various positions on the car 40. For example, a first capturing apparatus 50a may be arranged on or near the front bumper as a camera to monitor the front area of the car 40 as it travels. A second capturing apparatus 50b for monitoring the front area may be arranged near the inner rearview mirror inside the vehicle compartment of the car 40. A third capturing apparatus 50c may be arranged on the dashboard, inside the instrument panel or the like as a camera for monitoring the driver's driving condition. A fourth capturing apparatus 50d may be installed at the rear of the car 40 for monitoring the rear area of the car 40. The capturing apparatuses 50a and 50b may be referred to as front cameras. The third capturing apparatus 50c may be referred to as an in-camera. The fourth capturing apparatus 50d may be referred to as a rear camera. The capturing apparatuses 50 are not limited to these, but also include capturing apparatuses installed at various positions, such as a left-side camera capturing images on the left rear side and a right-side camera capturing images on the right rear side.

Image signals of the images captured by the capturing apparatuses 50 may be output to an information processing apparatus 42 and/or a display apparatus 43 or the like inside the car 40. The information processing apparatus 42 and display apparatus 43 constitute the in-vehicle system together with the capturing apparatuses 50. The information processing apparatus 42 inside the car 40 includes an apparatus that processes the image signals acquired by the capturing apparatuses 50, recognizes the recognition of various objects in the captured images, and assists the driver in driving. The information processing apparatus 42 also includes, but is not limited to, for example, a navigation apparatus, a collision damage reduction brake apparatus, a distance control apparatus, a lane departure warning apparatus, and the like. The display apparatus 43 displays the images processed and output by the information processing apparatus 42, and may also receive the image signals directly from the capturing apparatuses 50. The display apparatus 43 may also employ, but is not limited to, a Liquid Crystal Display (LCD), an organic EL (Electro-Luminescence) display, and an inorganic EL display. The display apparatus 43 may display to an occupant such as a driver the image signals output from the capturing apparatuses 50 that capture images at positions difficult to be seen by the driver, such as a rear camera.

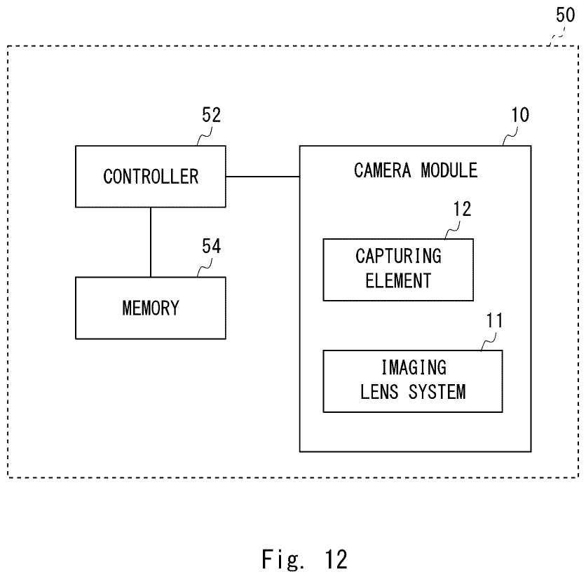

FIG. 12 shows the configuration of the capturing apparatus 50 constituting the in-vehicle system of FIG. 11. As shown in the drawing, the capturing apparatus 50 according to one embodiment includes a controller 52, a memory 54, and the camera module 10.

The controller 52 controls the camera module 10 and processes electrical signals output from the capturing element 12 of the camera module 10. The controller 52 may be configured as, for example, a processor. The controller 52 may also include one or more processors. The processor may include a general purpose processor that loads a specific program to perform a specific function, and a dedicated processor specialized in a specific process. The dedicated processor may include an application specific IC (Integrated Circuit). The application specific IC is also referred to as an ASIC (Application Specific Integrated Circuit). The processor may include a programmable logic device. A programmable logic device is also referred to as a PLD (Programmable Logic Device). A PLD may include a FPGA (Field-Programmable Gate Array). The controller 52 may be either a SoC (System-on-a-Chip) with one or more processors working together, or a SiP (System In a Package).

The memory 54 stores various information or parameters related to the operation of the capturing apparatuses 50. The memory 54 may be composed of, for example, a semiconductor memory and the like. The memory 54 may function as a work memory for the controller 52. The memory 54 may store the captured images. The memory 54 may store various parameters and the like for the controller 52 to perform detection processing based on the captured images. The memory 54 may be included in the controller 52.

As described above, the camera module 10 uses the capturing element 12 to capture a subject image formed through the imaging lens system 11, and outputs the imaged image. The image captured by the camera module 10 is also referred to as the captured image.

The capturing element 12 may be composed of, for example, a CMOS (Complementary Metal Oxide Semiconductor) image sensor, a CCD (Charge Coupled Device), or the like. The capturing element 12 has an imaging surface on which a plurality of pixels are arranged. Each pixel outputs a signal specified by current or voltage according to an incident light quantity. The signal output by each pixel is also referred to as imaging data.

The imaging data of all pixels may be read out by the camera module 10 and captured by the controller 52 as a captured image. The captured image read out for all pixels is also referred to as a maximum captured image. The imaging data of some pixels may be read out by the camera module 10 and captured as a captured image. In other words, the imaging data may be read out from pixels in a predetermined capture range. The imaging data read out from pixels in the predetermined capture range may be captured as a captured image. The predetermined capture range may be set by the controller 52. The camera module 10 may acquire the predetermined capture range from the controller 52. The capturing element 12 may capture an image of a predetermined capture range of the subject image formed through the imaging lens system 11.

Note that the present invention is not limited to the above-described examples, and they can be modified as appropriate without departing from the scope and spirit of the invention. For example, the use of the imaging lens system according to the present invention is not limited to on-board cameras and surveillance cameras, and instead can also be used for other uses such as cameras or the like used in small electronic apparatuses such as mobile phones.

This application is based upon and claims the benefit of priority from Japanese Patent Application No. 2022-113780, filed on Jul. 15, 2022, the disclosure of which is incorporated herein in its entirety by reference.

### INDUSTRIAL APPLICABILITY

An imaging lens system, a camera module, an in-vehicle system, and a vehicle, which can achieve a high resolution and are downsized, can be provided.

### REFERENCE SIGNS LIST

10 CAMERA MODULE
11 IMAGING LENS SYSTEM
12 CAPTURING ELEMENT
40 CAR (VEHICLE)
42 INFORMATION PROCESSING APPARATUS (PROCESSING APPARATUS)
43 DISPLAY APPARATUS (OUTPUT APPARATUS)
50 CAPTURING APPARATUS
52 CONTROLLER
L1 FIRST LENS
L2 SECOND LENS
L3 THIRD LENS
L4 FOURTH LENS
L5 FIFTH LENS
L6 SIXTH LENS
STOPIRIS
Gf FRONT LENS GROUP
Gr REARLENS GROUP
IRCF INFRARED CUT FILTER
IMG FOCAL PLANE
OA OPTICAL AXIS

1. An imaging lens system comprising, sequentially from an object side toward an image side:
a first lens having negative power with an image-side surface whose concave surface faces the image side; a second lens having negative power with an image-side surface whose concave surface faces the image side; a third lens having positive power with an image-side surface whose convex surface faces the image side; an iris; a fourth lens having positive power with an object-side surface whose convex surface faces the object side; and a fifth lens and a sixth lens constituting a cemented lens, one of the lenses having negative power and another of the lenses having positive power, wherein
the imaging lens system satisfies the following Conditional Expressions (1) to (4):
$$- 5. < f 1 / f < - 3. , \qquad ( 1 )$$
$$2.7 < f 4 / f < 3.1 , \qquad ( 2 )$$
$$vd 4 > 60 , and \qquad ( 3 )$$
$$6. < f 3 / f < 10. \qquad ( 4 )$$
where f1 is defined as a focal length of the first lens, f4 is defined as a focal length of the fourth lens, νd4 is defined as an Abbe's number of a d-line of the fourth lens, f3 is defined as a focal length of the third lens, and f is defined as a focal length of an entire optical system.

2. The imaging lens system according to claim 1, wherein the imaging lens system satisfies the following Conditional Expression (5):
$$9 < TTL / f < 11 \qquad ( 5 )$$
where TTL is defined as a distance on an optical axis from an object-side surface of the first lens to a focal plane of a capturing element, and f is defined as the focal length of the entire optical system.

3. The imaging lens system according to claim 1, wherein the imaging lens system satisfies the following Conditional Expression (6):
$$10. < \vert f 5 / f \vert < 30. \qquad ( 6 )$$
where f5 is defined as a focal length of the fifth lens, and f is defined as the focal length of the entire optical system.

4. The imaging lens system according to claim 2, wherein the imaging lens system satisfies the following Conditional Expression (6):
$$10. < \vert f 5 / f \vert < 30. \qquad ( 6 )$$
where f5 is defined as a focal length of the fifth lens, and f is defined as the focal length of the entire optical system.

5. The imaging lens system according to claim 1, wherein the imaging lens system satisfies the following Conditional Expression (7):
$$nd 1 > 1.8 \qquad ( 7 )$$
where nd1 is defined as a d-line refractive index of the first lens.

6. The imaging lens system according to claim 2, wherein the imaging lens system satisfies the following Conditional Expression (7):
$$nd 1 > 1.8 \qquad ( 7 )$$
where nd1 is defined as a d-line refractive index of the first lens.

7. The imaging lens system according to claim 3, wherein the imaging lens system satisfies the following Conditional Expression (7):
$$nd 1 > 1.8 \qquad ( 7 )$$
where nd1 is defined as a d-line refractive index of the first lens.

8. The imaging lens system according to claim 1, wherein
the first lens and the fourth lens are glass lenses, and
the second lens, the third lens, the fifth lens, and the sixth lenses are plastic lenses.

9. The imaging lens system according to claim 2, wherein
the first lens and the fourth lens are glass lenses, and
the second lens, the third lens, the fifth lens, and the sixth lens are plastic lenses.

10. The imaging lens system according to claim 3, wherein
the first lens and the fourth lens are glass lenses, and
the second lens, the third lens, the fifth lens, and the sixth lens are plastic lenses.

11. The imaging lens system according to claim 5, wherein
the first lens and the fourth lens are glass lenses, and
the second lens, the third lens, the fifth lens, and the sixth lens are plastic lenses.

12. The imaging lens system according to claim 1, wherein an object-side surface and the image-side surface of the second lens have aspherical surface shapes, and the object-side surface of the second lens has an inflection point.

13. The imaging lens system according to claim 2, wherein an object-side surface and the image-side surface of the second lens have aspherical surface shapes, and the object-side surface of the second lens has an inflection point.

14. The imaging lens system according to claim 3, wherein an object-side surface and the image-side surface of the second lens have aspherical surface shapes, and the object-side surface of the second lens has an inflection point.

15. The imaging lens system according to claim 5, wherein an object-side surface and the image-side surface of the second lens have aspherical surface shapes, and the object-side surface of the second lens has an inflection point.

16. The imaging lens system according to claim 8, wherein an object-side surface and the image-side surface of the second lens have aspherical surface shapes, and the object-side surface of the second lens has an inflection point.

17. A camera module comprising:
the imaging lens system according to claim 1; and
a capturing element configured to convert light condensed through the imaging lens system into an electrical signal.

18. An in-vehicle system mounted on a car comprising:
the camera module according to claim 17; and
an information processing apparatus configured to process a captured image output from the capturing element of the camera module and recognize an object in the captured image.

19. A vehicle on which the in-vehicle system according to claim 18 is mounted, further comprising an output apparatus configured to output information to an occupant, wherein the information processing apparatus is configured to output recognition information about the object to the output apparatus.
